(19) United States
(12) Patent Application Publication
(10) Pub. No.: US 2009/0225142 A1
(43) Pub. Date: Sep. 10, 2009

(54) LIQUID EJECTION HEAD, METHOD FOR MANUFACTUIRNG THE SAME, AND LIQUID EJECTING APPARATUS

(75) Inventor: Hiroyuki KAMIKURA, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/398,349

(22) Filed: Mar. 5, 2009

(30) Foreign Application Priority Data
Mar. 6, 2008 (JP) 2008-056890

(51) Int. Cl. B41J 2/19; C09J 5/02

(52) U.S. Cl. 347/92; 156/324.4; 347/20

(57) ABSTRACT

A liquid ejection head ejecting a liquid contained in a liquid reservoir from nozzle apertures through a plurality of liquid supply channels includes a first liquid supply member and a second liquid supply member that define the plurality of liquid supply channels. A filter is disposed between the first supply member and the second supply member. The filter includes a plurality of filter portions corresponding to the respective liquid supply channels and at least one joining portion disposed across the region between the filter portions to join the filter portions to each other. The first supply member and the second supply member are bonded together at the region corresponding to the joining portion of the filter with a resin joint that is made of a resin penetrating the joining portion.

### BACKGROUND

1. Technical Field

The present invention relates to a liquid ejection head ejecting liquid, a method for manufacturing the same, and a liquid ejecting apparatus including the liquid ejection head, and specifically to an ink jet recording head ejecting ink as liquid, a method for manufacturing the same, and an ink jet recording apparatus.

2. Related Art

In an ink jet recording head, which is a representative of liquid ejection heads, in general, ink is supplied to a head body from an ink cartridge or a liquid reservoir containing the ink through an ink supplier such as an ink supply needle removably inserted in the ink cartridge and an ink flow channel formed in a supply member, such as a cartridge case holding the ink cartridge. The ink supplied to the head body is ejected from a nozzle by operating a pressure generator, such as a piezoelectric element, provided to the head body.

However, the cartridge contains air with the ink, and when the cartridge is removed from or attached to the head, air may be trapped in the ink. Such air can be delivered to the head body and undesirably cause ejection failure such as dot missing. In order to overcome this problem, for example, Japanese Unexamined Patent Application Publication No. 2000-211130 discloses a head including a filter. The filter is disposed between the ink supply needle inserted into the ink cartridge and the supply member to remove air and foreign matter from the ink.

The filter and the supply member are fixed to each other by thermal welding or the like, and the ink supply needle and the supply member are fixed to each other by ultrasonic welding or the like.

In the structure disclosed in the above-cited patent document, the filter is fixed to the supply member in a region where the ink supply needle is fixed. Accordingly, the supply member requires an area used for fixing the filter according to the area of the filter, and also requires other areas where the ink supply needle and the filter are welded. It is therefore difficult to reduce the intervals between the ink supply needles, and accordingly the head becomes large.

In addition, if the area of the filter is excessively reduced to miniaturize the head having the structure disclosed in the above cited patent document, the driving voltage for driving the pressure generator, such as a piezoelectric element or a heating element, must be increased undesirably because of the increase of dynamic pressure.

In the structure in which the ink supply needle and the supply member are fixed by, for example, thermal welding, a gap may be formed between the ink supply needle and the supply member, and thus the ink may leak from the gap. The structure in which the filter and the ink supply needle are fixed to the supply member in different process steps leads to an increased cost.

A filter may be provided across a plurality of flow channels. This structure makes the handling easier than the case in which a plurality of filters are provided for respective flow channels. However, liquids running through the plurality of flow channels may be undesirably mixed.

These problems can arise not only in the ink jet recording head, but also in the liquid ejection head ejecting liquid other than ink.

### SUMMARY

An advantage of some aspects of the invention is that it provides a liquid ejection head having a structure in which liquids running through a plurality of flow channels are not mixed together even though a filter is provided across the plurality of flow channels, a method for manufacturing the liquid ejection head, and a liquid ejecting apparatus including the liquid ejection head.

According to an aspect of the invention, a liquid ejection head is provided which ejects a liquid contained in a liquid reservoir from nozzle apertures through a plurality of liquid supply channels. The liquid ejection head includes a first liquid supply member and a second liquid supply member that define the plurality of liquid supply channels, and a filter disposed between the first supply member and the second supply member. The filter includes a plurality of filter portions corresponding to the respective liquid supply channels, and at least one joining portion disposed across the region between the filter portions to join the filter portions to each other. The first supply member and the second supply member are bonded together at a region thereof corresponding to the joining portion of the filter with a resin joint that is made of a resin penetrating the joining portion.

The first and the second supply member and the joining portion of the filter are joined into one body with the resin joint. Thus, no region is required for welding the filter to the first supply member and the second supply member. Consequently, the effective area of the filter can be increased and the interval between the suppliers can be reduced. In addition, since the resin penetrating the joining portion between the flow channels seals the filter portions, the liquid ejection head can be miniaturized without mixing the liquids running through the plurality of flow channels even though the filter extends across the plurality of flow channels. In addition, it is not required that the effective area of the filter be reduced to miniaturize the head. It is accordingly not required that the driving voltage of the piezoelectric element be increased while the dynamic pressure is prevented from increasing. Furthermore, since the resin penetrates the joining portion of the filter, the regions between the liquid supply channels can be reliably sealed to prevent liquids from leaking between the flow channels.

Preferably, the first supply member and the second supply member each have a recess in a region opposing at least part of the joining portion, and the resin joint is formed by filling the recesses with the resin to integrate the first supply member and the second supply member together. Since the resin fills the recesses surrounding the joining portion of the filter, the filter can be reliably secured.

Preferably, the filter portions have fine pores, and the joining portion has a through hole having a larger diameter than the pores of the filter portions. This facilitates the penetration of the resin into the joining portion. Consequently, the filter, the first supply member and the second supply member are integrated together with reliability.

Preferably, the joining portion has a smaller width than the filter portions. Thus, the resin joint is formed so as to surround the joining portion to integrate the filter, the first supply member, and the second supply member with reliability.

Preferably, the first supply member and the second supply member have respective filter holding portions opposing each other and are in contact with the filter so as to surround the liquid supply channels. The filter portions have a shape corresponding to the outline of the filter holding portions. The resin fills the region outside the filter holding portions between the first supply member and the second supply member continuously from the resin joint, thus joining the first supply member and the second supply member together. Thus, the periphery of the filter is covered with the resin with a minimum area of the outer edge of the filter. Consequently, the liquid does not leak from a gap between the first supply member and the second supply member.

Preferably, the liquid ejection head further includes an outer portion around the first supply member, the second supply member and the filter. The outer portion is made of the same resin as the resin joint and continues to the resin joint. The outer portion joins the first supply member and the second supply member together. Since the first supply member and the second supply member are reliably joined with the outer portion, the liquids do not leak from the gap between the first supply member and the second supply member.

According to another aspect of the invention, a liquid ejection apparatus including the above-described liquid ejection head is provided. The liquid ejection apparatus can be small and manufactured in a low cost.

According to still another aspect of the invention, a method for manufacturing the liquid ejection head is provided. In the method, the first supply member and the second supply member are placed in a mold with the filter held therebetween. Then, a resin joint is formed by introducing a resin into a region corresponding to the joining portion between the first supply member and the second supply member so that the resin penetrates the joining portion of the filter to join the first supply member and the second supply member together.

In this instance, the resin penetrating the joining portion of the filter integrates the first supply member and the second supply member. Accordingly, no region is required to weld the first supply member and the second supply member to the filter. Consequently, the effective area of the filter can be increased and the interval between the suppliers can be reduced. Thus, the head can be miniaturized. In addition, it is not required that the area of the filter be reduced to miniaturize the head. It is accordingly not required that the driving voltage of the piezoelectric element be increased while the dynamic pressure is prevented from increasing. Furthermore, since the resin penetrates the joining portion of the filter, the region between the liquid supply channels can be more reliably sealed to prevent liquids from leaking between the flow channels.

Preferably, either the first supply member or the second supply member has a filling hole in a region thereof corresponding to the joining portion. The resin is introduced through the filling hole. The mold has a cavity surrounding the joining portion and a gate communicating with the cavity. Thus, the resin introduced from the gate through the filling hole can more easily penetrate the joining portion and thus more reliably seals the region between the liquid supply channels. Consequently, the liquids can be prevented from leaking between the flow channels with reliability.

### BRIEF DESCRIPTION OF THE DRAWINGS

The invention will be described with reference to the accompanying drawings, wherein like numbers reference like elements.

FIG. 1 is a schematic perspective view of a recording apparatus according to a first embodiment of the invention.

FIG. 2 is an exploded perspective view of a recording head according to the first embodiment of the invention.

FIG. 3 is a top view of a supply member of the recording head according to the first embodiment.

FIG. 4A is a plan view of a filter used in the supply member and FIG. 4B is a fragmentary enlarged top view of an essential part of the supply member shown in FIG. 3.

FIG. 5 is a sectional view of the supply member of the liquid ejection head according to the first embodiment.

FIG. 6 is a sectional view showing a method for preparing the supply member according to the first embodiment.

FIG. 7 is a sectional view showing the method for preparing the supply member according to the first embodiment.

FIG. 8 is an exploded perspective view of a head body of the recording head according to the first embodiment.

FIG. 9 is a sectional view of the head body shown in FIG. 8.

FIG. 10 is a sectional view of a supply member according to a second embodiment of the invention.

FIG. 11 is a sectional view of a filter according to the second embodiment.

### DESCRIPTION OF EXEMPLARY EMBODIMENTS

The invention will further be described with reference to exemplary embodiments.

### First Embodiment

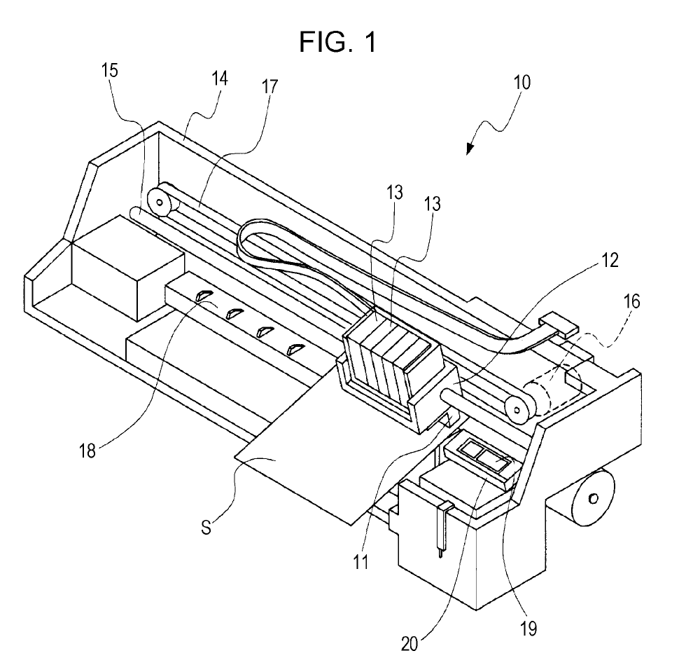

FIG. 1 is a schematic perspective view of an ink jet recording apparatus, which is a type of the liquid ejecting apparatus according to the first embodiment of the invention. The ink jet recording apparatus 10 of the first embodiment includes an ink jet recording head (hereinafter may be referred to as the recording head) 11 that is a liquid ejection head ejecting ink droplets. The recording head 11 is fixed to a carriage 12, and to which ink cartridges 13, or liquid reservoirs, are removably secured, as shown in FIG. 1. The ink cartridges 13 respectively contain a plurality of colors including black (B), light black (LB), cyan (C), magenta (M), and yellow (Y).

The carriage 12 having the recording head 11 is secured to a carriage shaft 15 fixed to the device body 14 and is movable along the shaft. The carriage 12 is moved along the carriage shaft 15 by transmitting the driving force from a driving motor 16 to the carriage 12 with a plurality of gears (not shown) and a timing belt 17. In the apparatus body 14, platen 18 is disposed along the carriage shaft 15 so that print medium S, such as paper, fed from a paper feed unit (not shown) or the like is transported over the platen 18.

A capping unit 20 having a cap member 19 sealing the nozzle region of the recording head 11 is disposed at a position corresponding to the home position of the carriage 12, that is, by one end of the carriage shaft 15. The cap member 19 seals the nozzle region having nozzle apertures, thereby preventing the inks from drying. The cap member 19 also acts as an ink receiver for flushing operation.

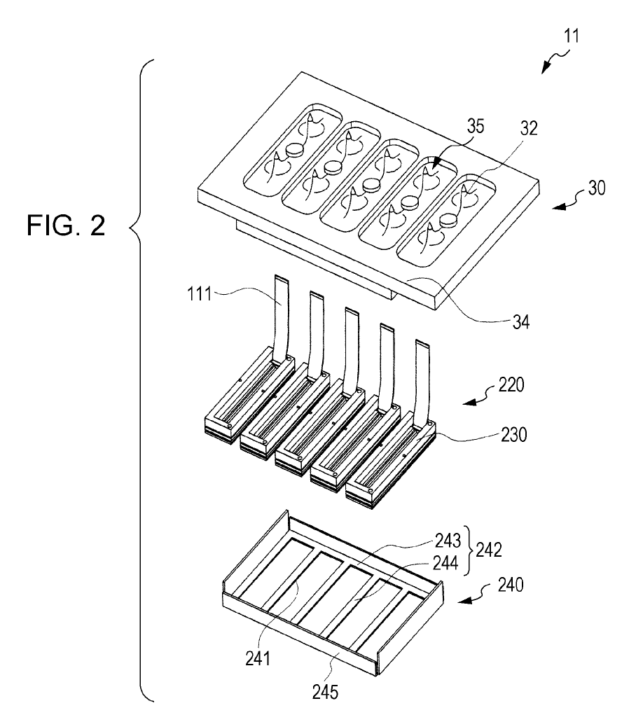

The recording head 11 of the present embodiment will now be described. FIG. 2 is an exploded perspective view of the ink jet recording head, which is a type of the liquid ejection head of the invention.

As shown in FIG. 2, the recording head 11 includes a supply member 30, such as a cartridge case in which the ink cartridge 13 or liquid reservoir is fixed, a head body 220 fixed to the opposite surface to the ink cartridge 13 of the supply member 30, and a cover head 240 provided at the liquid ejecting face of the head body 220.

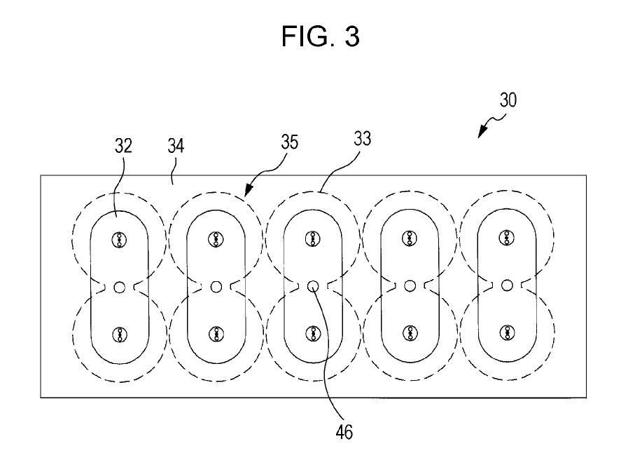

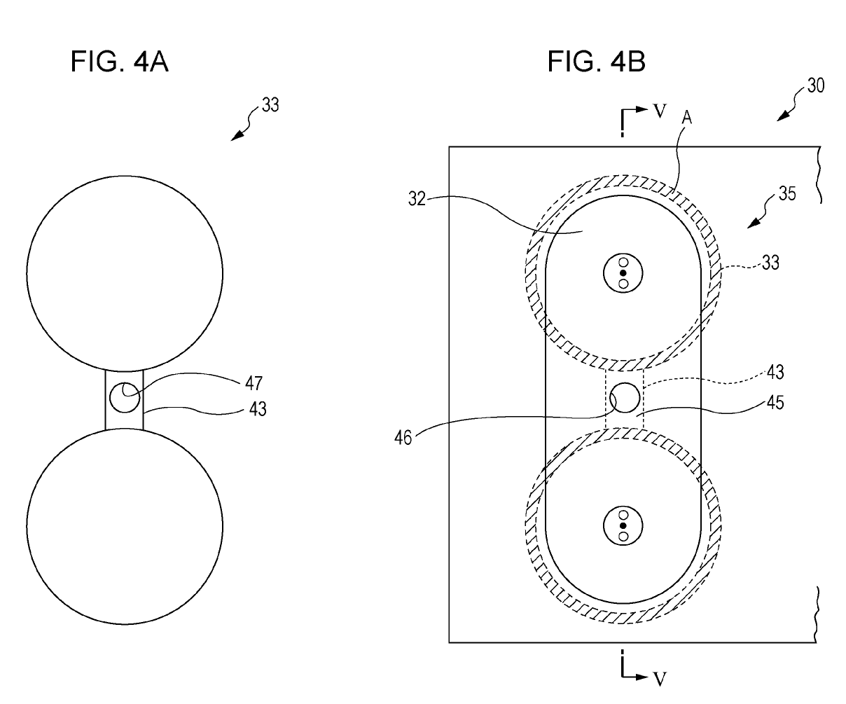

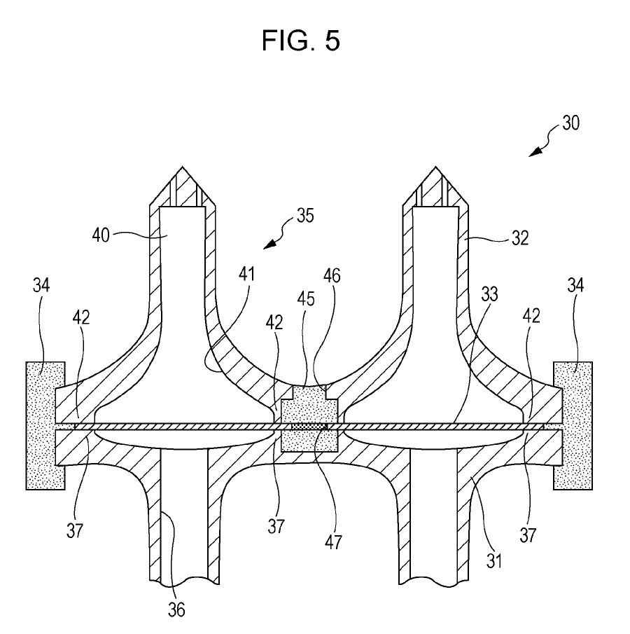

First, the supply member 30 will be described in detail. FIG. 3 is a top view of the supply member; FIGS. 4A and 4B are a plan view of the filter and a fragmentary enlarged top view of the essential part of the supply member, respectively; and FIG. 5 is a sectional view taken along line V-V in FIG. 4B.

As shown in FIG. 5, the supply member 30 includes a first supply sub-member and a second supply sub-member with the filter therebetween. In the present embodiment, a supply member body 31 acting as either the first or the second sub-member is disposed at the downstream side of the flow channels, and supply needles 32 acting as the other supply sub-member oppose the supply member body 31. The supply member body 31 and the supply needles 32 hold a filter therebetween and are integrated with an outer portion 34.

The supply member 30 has a supplier section 35 in which the ink cartridges 13 (liquid reservoirs) are disposed. The ink cartridges 13 may not directly be disposed in the supplier section 35, and liquid or ink may be delivered to the supplier section 35 through a tube from a liquid reservoir.

The supply member body 31 has liquid supply channels 36 downstream from the filter 33. Both ends of each liquid supply channel 36 are open and respectively communicate with the supplier section 35 and the head body 220, so that the liquid supply channel 36 can supplies the ink from the ink cartridge 13 to the head body 220. The liquid supply channels 36 are arranged in the longitudinal direction of the supply member body 31, and are independent from the ink cartridges 13 provided for respective colors.

The surface (supplier section 35) of the supply member body 31 acts as filter holding portions 37 in regions around the openings of the liquid supply channels 36. The filter 33 is secured between the filter holding portions 37 and the supply needles 32. The regions around the liquid supply channels 36 refer to surroundings adjacent to the openings of the liquid supply channels 36 and filter spaces 41. Preferably, the filter holding portions 37 are as close as possible from the viewpoint of saving space.

The supply needles 32 acting as the supplier are fixed to the surface (supplier section 35) of the supply member body 31, and each has a through-path communicating with the liquid supply channel 36 and thus acts as part of the liquid supply channel. The junction between the through-path 40 and the liquid supply channel 36 forms a space having a larger diameter than the other portions. This space is the filter space 41. In the present embodiment, the diameter of the filter space 41 increases toward the supply member body 31. The opening of the filter space 41 at the supply nozzle side acts as the liquid delivering hole. The ink is supplied from the ink cartridge 13 to the supply member body 31 through the liquid delivering hole.

Regions of the supply needles 32 surrounding the filter spaces 41 act as filter holding portions 42 at the bottom of the supply needle 32 at the supply member body side, and hold the filter 33 with the filter holding portions 37 of the supply member body 31.

The filter 33, held between the supply member body 31 and the supply needles 32, is a sheet formed by finely interweaving a metal and has fine pores. In the present embodiment, the filter 33 has such a size that can be held between the filter holding portions 37 and 42 of the supply member body 31 and the supply needles 32. FIG. 4A shows the external form of the filter 33, and FIG. 4B shows the regions (regions A) of the filter 33 held between the filter holding portions 37 and 42. The filter 33 has effective filter portions having a diameter substantially equal to the outer diameter of region A, which is slightly larger than the diameter of the liquid supply channel 36. The effective filter regions are joined with a joining portion 43. The joining portion 43 has a through hole 47 having a larger diameter than the pores of the filter.

The supply member body 31, the supply needles 32, and the filter 33 are provided with the outer portion 34 integrally formed by injection molding with the supply member body 31, the supply needles 32, and the filter 33 placed in a mold. The outer portion 34 is formed so as to surround the supply member body 31 and the supply needles 32 and reliably seal spaces formed by the outer edge of the filter 33 and the gaps between the supply member body 31 and the supply needles 32 and a region around the joining portion 43 of the filters 33, with the through-paths 40 and the liquid supply channels 36 isolated, thereby integrating the supply member body 31, the supply needles 32, and the filter 33. Thus, the outer portion 34 prevents the ink from leaking from the liquid supply channels 36.

In the present embodiment, two supply needles 32 are integrated into one member for two liquid supply channels. Hence, five members are provided for 10 liquid supply channels 36 (not shown), as shown in FIG. 3. The regions of the supply member body 31 and the supply needles 32 corresponding to the joining portion 43 of the filter 33 have recesses. The recesses are filled with a resin to form a connecting portion 45. The connecting portion 45 continues to the outer portion 34 and surrounds the joining portion 43 of the filters 33. The connecting portion 45 has a filling hole 46 communicating with a gate through which the resin of the outer portion 34 is introduced.

In the present invention, a single filter 33 is disposed so as to continue across the two liquid supply channels 36. Therefore, a through hole 47 is formed in the region of the joining portion 43 of the filter 33 corresponding to the filling hole 46 so that the resin introduced through the filling hole 46 can reach and fill the outer portion 34 with reliability. The through hole 47 of course may not be formed. A filter 33 may be provided for each of the ten liquid supply channels 36 and the plurality of filters 33 may be joined into one piece.

The resin delivered through the filling hole 46 penetrates the joining portion 43 of the filter 33 and is introduced to the rear side of the filter 33 through the through hole 47 to form the connecting portion 45. The connecting portion 45 is integrated with the supply member body 31 and the supply needles 32 in their recesses, thus acting as a resin joint that integrates the filter 33, the supply member body 31 and the supply needles 32 together. The resin delivered through the filling hole 46 further fills regions around the supply member body 31 and supply needles 32 to form the outer portion 34.

Thus, the connecting portion 45 reliably seals the region between the liquid supply channels 36 to prevent liquids from being mixed and integrates the supply member body 31, the supply needles 32 and the filter 33. In addition, since the outer portion 34 continues to the connecting portion 45, the supply member body 31, the supply needles 32 and the filter 33 are more reliably integrated.

The filter 33 of the present embodiment has such a size that can be held between the filter holding portions 37 and 42 around the liquid supply channels 36, as described above. The resin penetrates around the filter 33 along the periphery of the filter 33, thus forming the outer portion 34. Thus, the outer portion 34 further reliably integrates the supply member body 31, the supply needles 32 and the filter 33 together, thereby reliably sealing the periphery of the filter 33 with resin.

As described above, the connecting portion 45 and the outer portion 34 ensure the integration of the supply member body 31, the supply needles 32 and the filter 33, and thus the supply member 30 is formed in a single body. BY integrating the supply member body 31, the supply needles 32 and the filter 33 with the integrated connecting portion 45 and outer portion 34, no region is required for welding the supply needles 32 and the filter 33 to the supply member body 31. Consequently, the interval between the supply needles 32 can be reduced, and the liquids flowing adjacent liquid supply channels can be prevented from leaking. Thus, the head can be miniaturized. In addition, it is not required that the area of the filter 33 be reduced to miniaturize the head. It is accordingly not required that the driving voltage of the piezoelectric element 300 be increased while the dynamic pressure is prevented from increasing.

Since the connecting portion 45 and the outer portion 34 can simultaneously fix the filter 33 and the supply needles 32 to the supply member body 31, there is no need to fix the filter 33 and the supply needles 32 to the supply member body 31 in different process steps. Consequently, the manufacturing cost can be reduced.

Furthermore, since the supply member body 31, the supply needles 32 and the filter 33 can be reliably secured with the connecting portion 45 and the outer portion 34, gaps are not formed between the supply member body 31 and the supply needles 32. Consequently ink leakage can be prevented.

The outer portion 34 is not necessarily required. In order to seal the liquid supply channels 36 from each other by simultaneously fixing the filter 33 and the supply needles 32 to the supply member body 31, only the connecting portion 45 may be provided. Even though the outer portion 34 is provided, the outline of the filter 33 may be the same or slightly larger than that of the supply member body 31 and supply needless 32 without being limited to the embodiment.

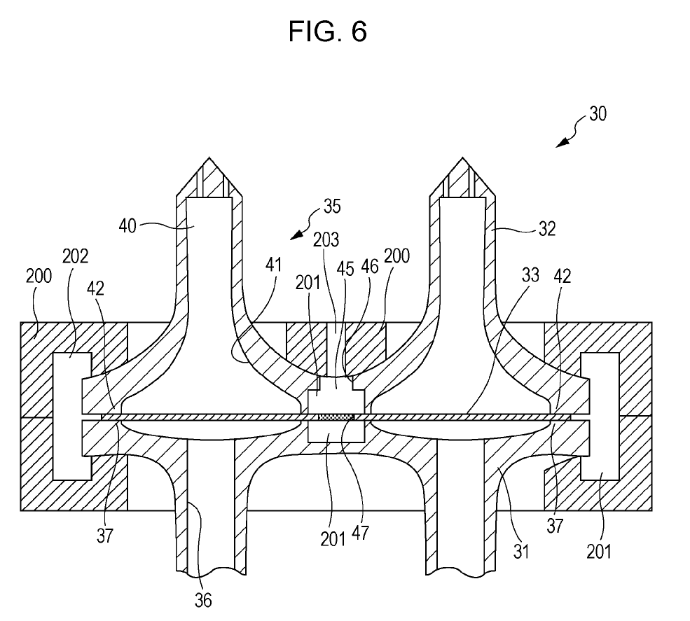

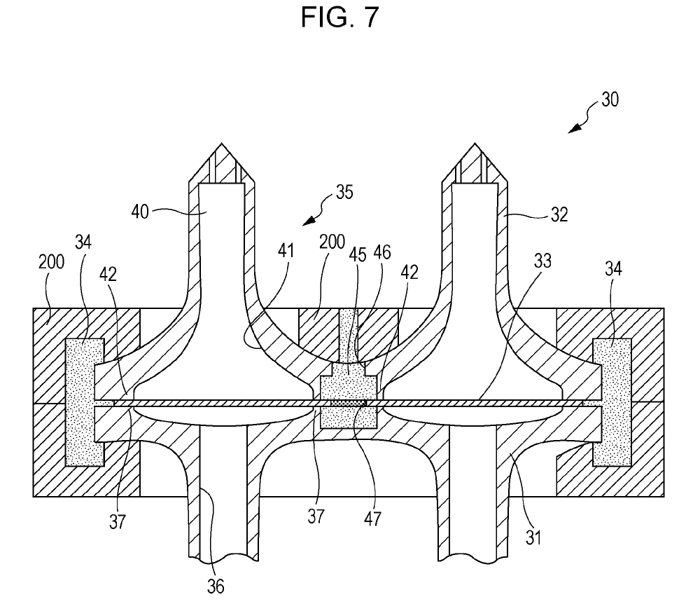

The method for manufacturing the ink jet recording head 11, particularly for preparing the supply member 30, will now be described. FIGS. 6 and 7 are sectional views showing the method for preparing the supply member.

First, the filter 33 is held between the supply member body 31 and the supply needles 32, as shown in FIG. 6. More specifically, the filter 33 held between the filter holding portion 37 of the supply member body 31 and the filter holding portion 42 of the supply needles 32 is placed in a mold 200. In this instance, the supply member body 31 and the supply needles 32 may be independently prepared and then placed in the mold 200, or may be formed in the mold 200 and subsequently subjected to the above integration.

The mold 200 includes an upper member and a lower member, and has cavities 201 and 202 in which the connecting portion 45 and the outer portion 34 are formed, and a gate 203 communicating with the cavity 201.

Then, a resin is introduced through the gate 203 to fill the cavities 201 and 202, thus integrally forming the outer portion 34 to complete the supply member 30, as shown in FIG. 7. More specifically, a molten resin is introduced through the gate 203 to fill the cavities 201. The resin penetrates the junction portion 43 of the filter 33 and flows through the through hole 47 to fill the cavity 201, thus forming the connecting portion 45. The resin also flows from the cavity 201 along the periphery of the filter 33 between the supply member body 31 and the supply needles and thus fills the cavity 202 to form the outer portion 34.

Thus, the filter 33 is joined and integrated with the supply member body 31 and the supply needles 32 with the connecting portion 45. Consequently, the region between the liquid supply channels 36 can be reliably sealed. The outer portion 34 extends over the entire region around the supply member body 31 and supply needles 32. Consequently, the supply member body 31, the supply needles 32 and the filter are joined into one body.

The filter 33 has the through hole 47, as described above. The through hole 47 allows the fused resin to pass therethrough and helps the resin easily flow in the vertical direction in the cavity 201 of the mold 200, and thus facilitates the introduction of the resin into the mold 200.

The supply member 30 does not require different process steps for welding the filter 33 and the supply needles 32 to the supply member body 31, and allows the supply member body 31, the supply needles 32 and the filter to be integrated together by a single step integrally forming the outer portion 34 with those parts. Thus, the manufacturing process can be simplified to reduce the cost.

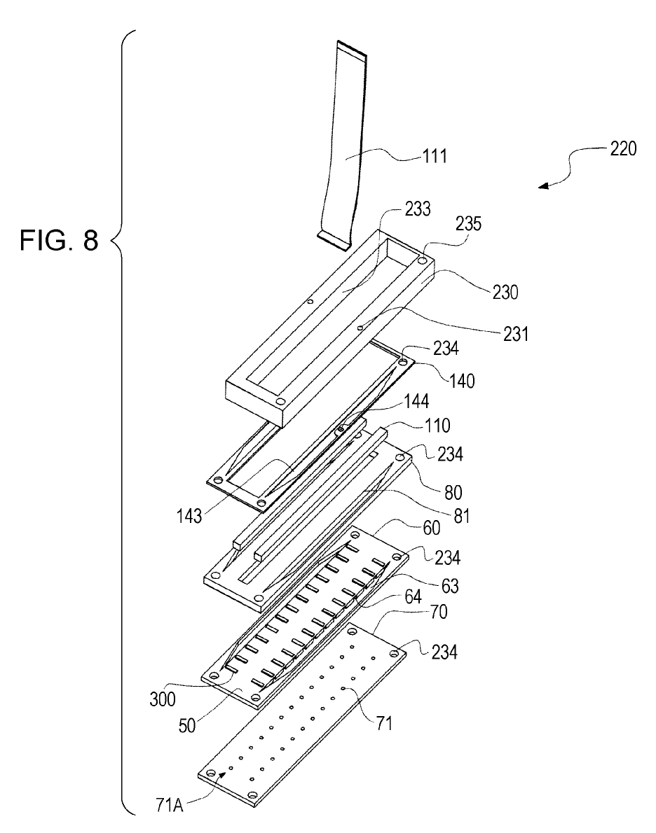

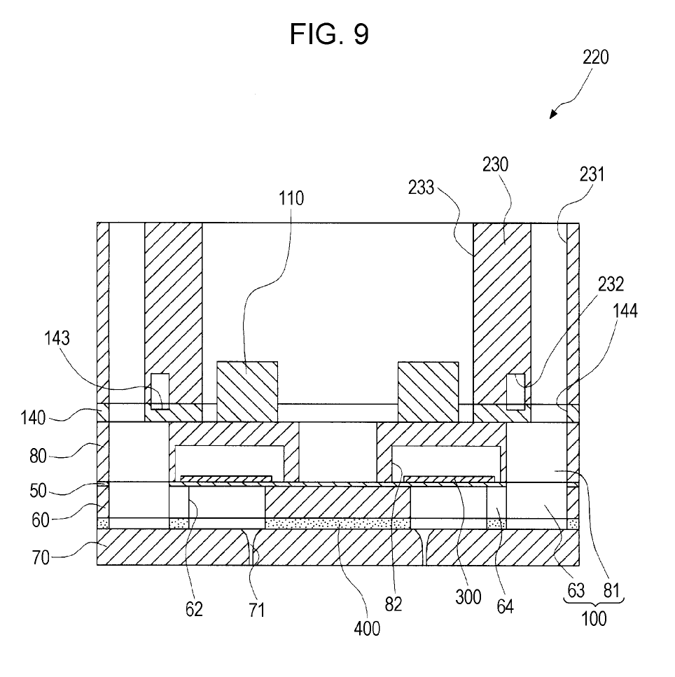

The head body 220 is disposed at the other side of the liquid supply channels 36 of the supply member 30, that is, at the opposite side to the supply needles 32. The head body 220 will now be described. FIG. 8 is an exploded perspective view of the head body and FIG. 9 is a sectional view of the head body.

As shown in these figures, the head body 220 includes a monocrystalline silicon flow channel substrate 60 and a silicon dioxide elastic film 50 on one surface of the flow channel substrate 60. The flow channel substrate 60 has pressure generating chambers 62 separated by a plurality of partition members. The pressure generating chambers 62 are formed by anisotropic etching of the flow channel substrate 60, and are arranged in two lines parallel to each other in the width direction of the head body 220. A communicating section 63 is formed to the outside of the pressure generating chambers 62 in the longitudinal direction of the pressure generating chambers 62. The communicating section 63 communicates with a reservoir section 81 formed in a below-described reservoir substrate 80 to form a reservoir 100 acting as a common ink chamber of the pressure generating chambers 62. The communicating section 63 communicates with one ends of the pressure generating chambers 62 through the ink supply channels 64. Hence, in the present embodiment, the pressure generating chambers 62, the communicating section 63 and the ink supply channels 64 are formed as liquid flow channels in the flow channel substrate 60.

A nozzle plate 70 having nozzle apertures 71 are fixed to the open side surface of the flow channel substrate 60 with an adhesive 400. More specifically, nozzle plates 70 are disposed corresponding to a plurality of head bodies 220. The nozzle plate 70 has a slightly larger area than exposing opening 241 of a below-described cover head 240 and secured using the overlap with the cover head 240 with an adhesive or the like. The nozzle apertures 71 in the nozzle plate 70 are formed so as to communicate with the respective pressure generating chambers 62 at the opposite side to the ink supply channels 64. In the present embodiment, the flow channel substrate 60 has two lines of the pressure generating chambers 62. Accordingly, the single head body 220 has two nozzle lines 71A in which the nozzle apertures 71 are aligned. Liquid is ejected from the liquid ejection face, which is the surface of the nozzle plate 70 in which the nozzle apertures 71 are formed. The nozzle plate 70 may be made of monocrystalline silicon, stainless steel (SUS), or a metal.

At the opposite side of the flow channel substrate 60 to the surface in which the openings are formed, piezoelectric elements 300 are disposed. The piezoelectric element 300 includes a metal lower electrode film, a piezoelectric layer made of lead zirconate titanate (PZT) or the like, and a metal upper electrode film that are formed in that order on the elastic film 50.

A reservoir substrate 80 having reservoir sections 81, each acting as at least part of the reservoir 100 is joined on the flow channel substrate 60 having the piezoelectric elements 300. The reservoir section 81 passes through the thickness of the reservoir substrate 80 and extends along the widths of the pressure generating chambers 62. Thus, the reservoir section 81 communicates with the communicating section 63 of the flow channel substrate 60 to form the reservoir 100 acting as the common ink chamber of the pressure generating chambers 62.

Piezoelectric element-protecting sections 82 are formed in the reservoir substrate 80 corresponding to the piezoelectric elements 300. The Piezoelectric element-protecting section has a space so that the piezoelectric element 300 can operate without interference.

In addition, driving circuits 110 are disposed on the reservoir substrate 80. Each driving circuit 110 includes a semiconductor integrated circuit (IC) or the like and operates the piezoelectric elements 300. The terminals of the driving circuit 110 are connected to the leads extracted from the electrodes of the piezoelectric elements 300 with bonding wires (not shown) or the like. The terminals of the driving circuit 110 are connected to the external devices with external leads 111 of a flexible printed circuit (FPC) or the like, and the driving circuit 110 receives various types of signals, such as printing signals, from the external devices through the external leads 111.

A compliance substrate 140 is further disposed on the reservoir substrate 80. The compliance substrate 140 has ink introducing holes 144 passing through the thickness of the compliance substrate 140 at the positions opposing the reservoirs 100. Ink is introduced into the reservoir 100 through the ink introducing hole 144. The compliance substrate 140 also has thin flexible portions 143 in the region opposing the reservoirs 100 other than the regions having the ink introducing holes 144. The flexible portion 143 seals the reservoir 100. The flexible portion 143 applies a compliance level to the inside of the reservoir 100.

A head case 230 is secured on the compliance substrate 140.

The head case 230 has an ink supply communication path 231 communicating with the ink introducing hole 144 and the liquid supply channels 36 of the supply member 30. Thus, ink is delivered from the supply member 30 to the ink introducing hole 144 through the ink supply communication path 231. The head case 230 has grooves 232 in the region opposing the flexible portions 143 of the compliance substrate 140 so that the flexible portions 143 can be appropriately deformed. The head case 230 also has a driving circuit holder 233 in the regions opposing to the driving circuits 110 disposed on the reservoir substrate 80. The driving circuit holder 233 is formed so as to pass through the thickness of the head case 230, and the external leads 111 are connected to the driving circuits 110 through the driving circuit holder 233.

The head body 220 is held in the supply member 30 with the head case 230 therebetween. Thus, five head bodies 220 are relatively positioned with the liquid ejection faces covered with the box-like cover head 240, as shown in FIG. 2. The cover head 240 has exposing openings 241 at which the nozzle apertures 71 are exposed, and a joint portion 242 defining the exposing openings 241 and connected to the liquid ejection faces of the head body at least at both ends of the nozzle lines 71A of the nozzle apertures 71.

The joint portion 242 includes a frame 243 disposed along the sides of the area defined by all of the liquid ejection faces of the head bodies 220, and beams 244 extending between the head bodies 220 and separating the exposing openings 241. The frame 243 and the beams 244 are joined to the liquid ejection faces of the head bodies 220, that is, the surface of the nozzle plate 70.

The cover head 240 also has a side wall 245 covering the periphery of the region defined by all of the liquid ejection faces.

The cover head 240 is joined to the head bodies 220 by bonding the joint portion 242 to the liquid ejection faces of the head bodies 220. This structure reduces the step height between the liquid ejection faces and the cover head 240. Consequently, ink does not remain on the liquid ejection faces after wiping of the liquid ejection faces or suctioning. Also, the beams 244 fill the gaps between the head bodies 220 to prevent the ink from penetrating between the head bodies. Consequently, the piezoelectric elements 300 and the driving circuits 110 are protected from degradation or damage caused by the ink. The gap between the liquid ejection faces of the head bodies 220 and the cover head 240 is completely filled with an adhesive, so that the print medium S is not trapped by the gap. Consequently, the deformation of the cover head 240 or paper jam can be prevented. Furthermore, the side wall 245 covers the periphery of the region defined by all of the head bodies 220 to reliably prevent the ink from flowing to the sides of the head bodies 220. The cover head 240 has the joint portion 242 joined to the liquid ejection faces of the head bodies 220. Consequently, the head bodies 220 are joined to the cover head 240 with the nozzle lines 71A of the head bodies 220 precisely positioned with respect to the cover head 240.

The cover head 240 can be made of, for example, stainless steel or other metal by presswork or metal forming. Such an electroconductive metal cover head 240 can be grounded. The cover head 240 and the nozzle plate 70 can be joined together by any technique without particular limitation, and may be bonded with an adhesive, such as a thermosetting epoxy adhesive or a UV-curable adhesive.

The ink jet recording head 11 of the present embodiment draws an ink through the liquid supply channel 36 from the ink cartridge 13. The ink is delivered through the ink supply communication path 231 and the ink introducing hole 144 to fill the spaces from the reservoir 100 to the nozzle apertures 71. Then, the ink jet recording head 11 applies a voltage to the piezoelectric elements 300 corresponding to the pressure generating chamber 62 according to the recording signal from the driving circuit 110. Thus, the elastic film 50 and the piezoelectric element 300 are deformed to increase the internal pressure in the pressure generating chambers 62, thereby ejecting the ink from the nozzle apertures 71.

### Second Embodiment

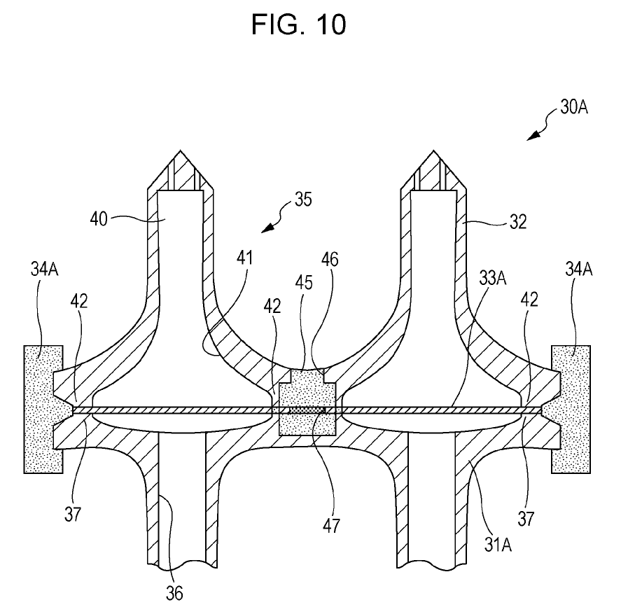

FIG. 10 is a sectional view of a supply member according to a second embodiment. The supply member 30A of the second embodiment has the same structure as in the first embodiment, except that the outer region of the filter 33 slightly protrudes into the outer portions 34. The same parts as in the first embodiment are designated by the same reference numerals and the descriptions will not be repeated.

As shown in FIG. 10, the filter 33A is slightly larger than the outer diameters of the filter holding portions 37 and 42 of the supply member body 31A and the supply needles 32, and the outer region of the filter 33A is held by the outer portion 34A. The outer region from the filter holding portion 37 of the supply member body 31A and the outer region from the filter holding portion 42 of the supply needles 32 are formed lower than the filter holding portions 37 and 42 in height, so that the resin of the outer portion 34A can easily fill the gap. Thus, the outer portion 34A can reliably hold the outer region of the filter 33A.

### Modifications

Although exemplary embodiments of the invention have been described, the invention is not limited to those embodiments.

For example, the first supply sub-member and the second supply sub-member is not limited to the structure described above. While the first supply sub-member acts as the supply member body and the second supply sub-member acts as the supply needles in the above embodiments, their functions may be reversed. While the entirety of the supply member body 31 or 31A connected to the head body 220 defines the first supply sub-member, the supply member body 31 or 31 may be divided between the filter 33 side and the head body 220 side. The head body 220 side may be used as the first supply member to integrate with the filter 33 and the supply needles 32. In this instance, the head body 220 side is incorporated into an integrated member of the filter and the supply needles to form the supply member 30.

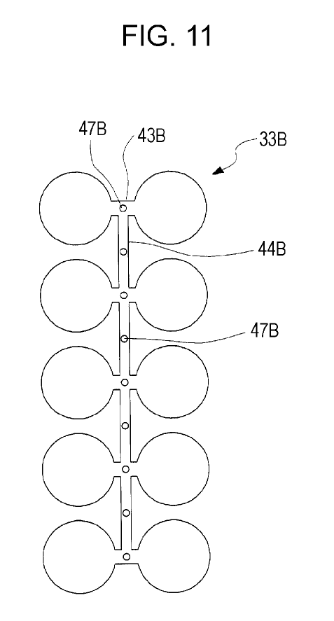

Although two supply needles 32 are integrated into a single member and the supply needles 32 and the supply member body 31 are further integrated with the outer portion 34, in the above embodiments, the outer portion 34 may be simultaneously formed to seal ten liquid supply channels 36 and thus conduct integration, without particular limitation. In this instance, five two-portion filters may be used, or a filter sealing ten liquid supply channels 36 may be used. FIG. 11 shows such a ten-portion filter including ten filter portions. The filter 33B includes five sets of two-portion filter formed by joining the two filter portions corresponding to two liquid supply channels 36 with a joining portion 43B. The five sets are connected to each other with joining portions 44B. For easy introduction of the resin forming the outer portions, through holes 47B are formed in the joining portions 43B and 44B. For easy formation of the connecting portion and the outer portion, the joining portions 43B and 44B are formed into thin straps. There is no need to say that the joining portions 43B and 44B may not be in a strap shape, and that the through holes 47B may not be formed in the joining portions 43B and 44B.

The joining portions 43 of the filter 33 may not have the same shape as the connecting portion 45 acting as a resin joint. For example, in the filter 33 shown in FIG. 4B, the width of the connecting portion 45 may be increased in the direction perpendicular to line V-V and is thus larger than the width of the joining portion 43 of the filter 33. Consequently, the resin can easily flow around the joining portion 43 of the filter 33.

While the ink cartridge 13 or liquid reservoir is removably secured to the supply member 30 in the above embodiments, an ink tank or the like acting as the liquid reservoir may be disposed in a position other than the recording head 11 and the liquid reservoir is connected to the recording head 11 with a tube or other feed pipes. In other words, the supplier is not limited to a needle type as used in the first embodiment in which the supply needles 32 are used as the suppliers.

While a single head body 220 is provided for a plurality of liquid supply channels 36 in the above-described embodiments, a plurality of head bodies may be provided for respective colors. In this instance, the liquid supply channels 36 may communicate with the respective head bodies. More specifically, the liquid supply channels 36 may be disposed so as to communicate with the respective nozzle lines of nozzle apertures of the head bodies. The liquid supply channels 36 may not communicate with the respective nozzle lines of course. For example, a single liquid supply channel 36 may communicate with a plurality of nozzle lines, or a single nozzle line may be divided into two sub lines communicating with respective liquid supply channels 36. Any form can be taken as long as the liquid supply channel 36 communicates with a group of nozzle apertures.

While the invention has been described using an ink jet recording head 11 ejecting ink droplets in the above embodiments, the invention is intended for general liquid ejection heads. Exemplary liquid ejection heads include recording heads used in image recording apparatuses such as printers, color material ejection heads used for manufacturing color filters of liquid crystal displays, electrode material ejection heads used for forming electrodes of organic EL displays or FEDs (field emission displays), and bioorganic material ejection heads used for manufacturing bio-chips.

The entire disclosure of Japanese Patent Application No. 2008-056890, filed Mar. 6, 2008 is incorporated by reference herein.

What is claimed is:

1. A liquid ejection head ejecting a liquid contained in a liquid reservoir from nozzle apertures through a plurality of liquid supply channels, the liquid ejection head comprising:
a first liquid supply member and a second liquid supply member that define the plurality of liquid supply channels; and
a filter disposed between the first supply member and the second supply member, including a plurality of filter portions corresponding to the respective liquid supply channels and at least one joining portion disposed across the region between the filter portions to join the filter portions to each other,
wherein the first supply member and the second supply member are bonded together at a region thereof corresponding to the joining portion of the filter with a resin joint that is made of a resin penetrating the joining portion.

2. The liquid ejection head according to claim 1, wherein the first supply member and the second supply member each have a recess in a region opposing at least part of the joining portion, and the resin joint is formed by filling the recesses with the resin to integrate the first supply member and the second supply member together.

3. The liquid ejection head according to claim 1, wherein the filter portions have fine pores, and the joining portion has a through hole having a larger diameter than the pores of the filter portions.

4. The liquid ejection head according to claim 1, wherein the joining portion has a smaller width than the filter portions.

5. The liquid ejection head according to claim 1, wherein the first supply member and the second supply member have respective filter holding portions opposing each other and being in contact with the filter so as to surround the liquid supply channels, and the filter portions have a shape corresponding to the outline of the filter holding portions, and wherein the resin fills the region outside the filter holding portions between the first supply member and the second supply member continuously from the resin join, thus joining the first supply member and the second supply member together.

6. The liquid ejection head according to claim 1, further compositing an outer portion around the first supply member, the second supply member and the filter, the outer portion being made of the same resin as the resin joint and continues to the resin joint, the outer portion joining the first supply member and the second supply member together.

7. A liquid ejecting apparatus comprising the liquid ejection head as set forth in claim 1.

8. A method for manufacturing a liquid ejection head ejecting a liquid contained in a liquid reservoir from nozzle apertures through a plurality of liquid supply channels, the liquid ejection head including a first supply member and a second supply member that define the plurality of liquid supply channels, and a filter disposed between the first supply member and the second supply member and including a plurality of filter portions corresponding to the respective liquid supply channels and at least one joining portion disposed across the region between the filter portions to join the filter portions to each other, the method comprising:
placing the first supply member and the second supply member with the filter held therebetween in a mold; and
forming a resin joint by introducing a resin into the region corresponding to the joining portion between the first supply member and the second supply member so that the resin penetrates the joining portion of the filter to join the first supply member and the second supply member together.

9. The method according to claim 8, wherein one of the first supply member and the second supply member has a filling hole in a region thereof corresponding to the joining portion, and the resin is introduced through the filling hole, and wherein the mold has a cavity surrounding the joining portion and a gate communicating with the cavity.
